(19) United States
(12) Patent Application Publication
(10) Pub. No.: US 2005/0160386 A1
(43) Pub. Date: Jul. 21, 2005

(54) Systems and methods for filtering circuit analysis results

(76) Inventors: Michael Peter Mortensen, Fort Collins, CO (US); John Gilbert McBride, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/760,951

(22) Filed: Jan. 20, 2004

(51) Int. Cl. G06F 17/50

(52) U.S. Cl. 716/4

(57) ABSTRACT

Systems and methods for filtering circuit analysis results are disclosed, and involve receiving circuit analysis results, identifying a duplicate circuit analysis result among the received circuit analysis results, and outputting a list of circuit analysis results that excludes the duplicate circuit analysis result.

### BACKGROUND

Electrical rules checking (ERC) is a process of examining a circuit design to ensure that circuit design rules are not violated. ERC checks, which may be performed at the transistor level of a circuit, help ensure that a circuit is reliable. The analysis of circuits may be based on logical circuit groupings, whereby related transistors that perform a predetermined function are examined as a group (or cluster). An ERC software tool may examine each cluster independently of other clusters to detect ERC violations. A cluster that includes multiple transistors also includes one or more nets (electrical connections between transistors). Each net may appear in multiple clusters. For example, a net may be coupled to a driver FET (field effect transistor) in one cluster and to receiver FETs in other clusters.

Many ERC checks are net-based. Since a net may appear in multiple clusters, the same net could be subject to multiple ERC checks. This may result in duplicate ERC results whereby the same ERC violation is detected in multiple clusters. Furthermore, each cluster may have structural properties that result in an ERC violation being detected multiple times. Providing a user of an ERC software tool with duplicate ERC violations may be confusing to the user and may result in the user spending a significant amount of time examining the ERC violations.

### SUMMARY

Systems and methods for filtering circuit analysis results are disclosed. An embodiment of a method, among others, for filtering circuit analysis results includes the following steps: receiving circuit analysis results, identifying a duplicate circuit analysis result among the received circuit analysis results, and outputting a list of circuit analysis results that excludes the duplicate circuit analysis results.

An embodiment of a system, among others, for filtering circuit analysis results includes memory configured to store program code, and at least one processor that is programmed by the program code to identify duplicate circuit analysis results, and to output a list of circuit analysis results that excludes the duplicate circuit analysis results.

### BRIEF DESCRIPTION OF THE DRAWINGS

Systems and methods for filtering circuit analysis results are illustrated by way of example and not limited by the implementations illustrated in the following drawings. The components in the drawings are not necessarily to scale. Like reference numerals designate corresponding parts throughout the several views.

FIG. 1 is a block diagram depicting a computer according to an embodiment of the invention.

FIG. 1A is a flow chart depicting an embodiment of a method for filtering circuit results that may be implemented by the computer depicted in FIG. 1.

FIG. 2 is a flow chart depicting an embodiment of a method for filtering circuit analysis results that may be implemented by the computer depicted in FIG. 1.

FIG. 3 is a flow chart depicting an embodiment of a method for filtering circuit analysis results that may be implemented by the computer depicted in FIG. 1.

FIG. 4 is a flow chart depicting an embodiment of a method for filtering circuit analysis results that may be implemented by the computer depicted in FIG. 1.

FIG. 5 is a flow chart depicting an embodiment of a method for filtering circuit analysis results that may be implemented by the computer depicted in FIG. 1.

FIG. 6 is a flow chart depicting an embodiment of a method for filtering circuit analysis results that may be implemented by the computer depicted in FIG. 1.

FIG. 7 is a flow chart depicting an embodiment of a method for filtering circuit analysis results that may be implemented by the computer depicted in FIG. 1.

FIG. 8 is a flow chart depicting an embodiment of a method for filtering circuit analysis results that may be implemented by the computer depicted in FIG. 1.

FIG. 9 is a flow chart depicting an embodiment of a method for filtering circuit analysis results that may be implemented by the computer depicted in FIG. 1.

### DETAILED DESCRIPTION

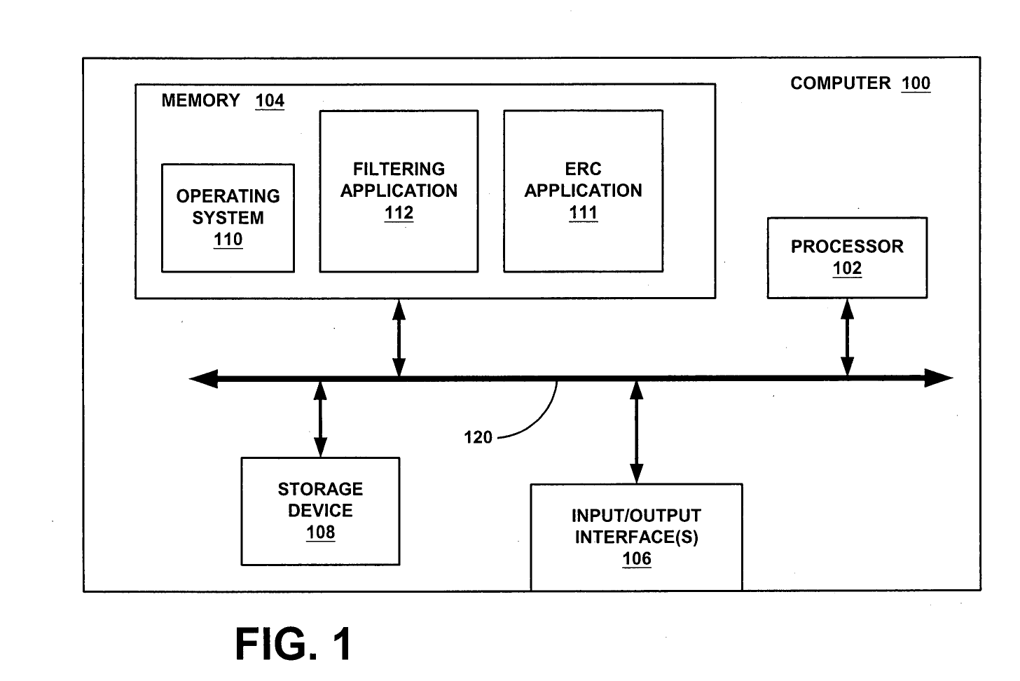

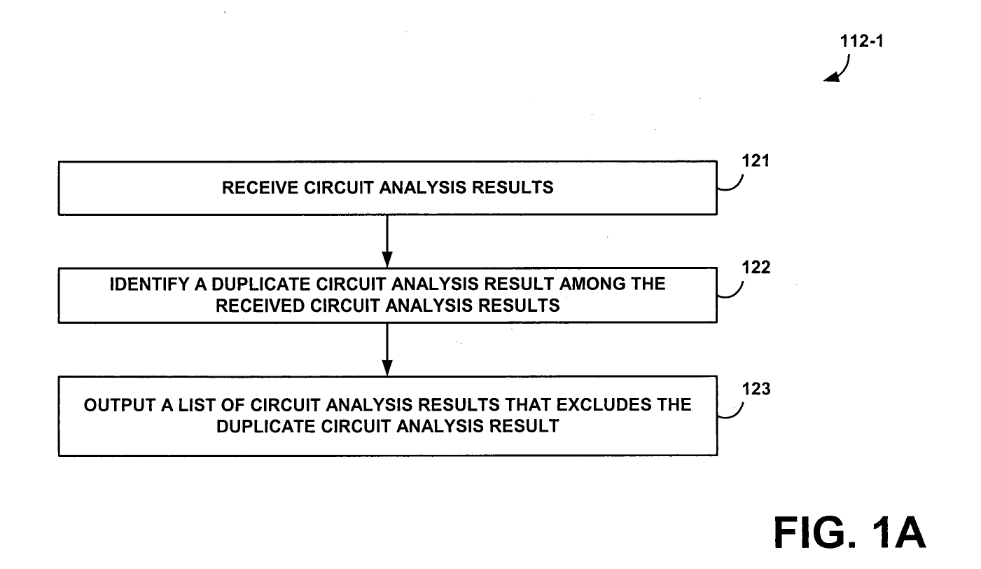

FIG. 1 is a block diagram depicting a computer 100 according to an embodiment of the invention. The computer 100 may be, for example, a desktop computer (e.g., IBM-compatible, Apple-compatible, or otherwise), a notebook computer, a workstation, a minicomputer, a personal digital assistant (PDA), or a mainframe computer.

Generally, in terms of hardware architecture, as shown in FIG. 1, the components of the computer 100 include a processor 102, memory 104, input/output (I/O) interfaces 106, and a storage device 108. These components (102, 104, 106, and 108) may be communicatively coupled via a local interface 120, which may comprise, for example, one or more buses or other wired or wireless connections. The local interface 120 may have additional elements, which are omitted for simplicity, such as controllers, buffers (caches), drivers, repeaters, and receivers, to enable communications.

The processor 102 is a hardware device for executing software, particularly that stored in memory 104. The processor 102 can be any custom made or commercially available processor, a central processing unit (CPU), an auxiliary processor among several processors associated with the computer 100, a semiconductor based microprocessor (in the form of a microchip or chip set), or generally any device for executing software instructions. When the computer 100 is in operation, the processor 102 is configured to execute software stored within the memory 104, to communicate data to and from the memory 104, and to generally control operations of the computer 100 pursuant to the software.

The I/O interfaces 106 may be used to communicate with one or more peripheral devices including, for example, a printer, a copier, a keyboard, a mouse, and/or a monitor, etc. The I/O interfaces 106 may include, for example, a serial port, a parallel port, a Small Computer System Interface (SCSI), an IR (infra-red) interface, an RF (radio frequency) interface, and/or a universal serial bus (USB) interface.

The memory 104 can include any one or combination of volatile and/or non-volatile memory elements now known or later developed. For example, the memory 104 may comprise random access memory (RAM), read only memory (ROM), a hard disk, a tape, and/or a compact disk ROM (CD-ROM), among others. Note that the memory 104 can have a distributed architecture, where various components are situated remote from one another, but can be accessed by the processor 102.

The storage device 108 can be used for storing circuit analysis results before and/or after they are filtered by the filtering application 112. The storage device 108 may comprise nonvolatile memory, such as, for example, a hard disk.

The software applications in memory 104 include an operating system (OS) 110, an ERC (electrical rules checking) application, and a filtering application 112. The OS 110 essentially controls the execution of the other applications, and provides scheduling, input-output control, file and data management, memory management, and/or communication control, among other functionality. The ERC application may be configured to use electrical rules checking techniques to analyze data that describes a circuit design, and to output circuit analysis results. The filtering application 112 may be used to filter the circuit analysis results (e.g., delete duplicate results).

The ERC application 111 and the filtering application 112 may each be a source program, an executable program (e.g., object code), a script, or any other entity comprising a set of instructions to be executed. In one embodiment, functionality of the ERC application and the filtering application 112 may be performed by a single application or by multiple applications, depending on a desired implementation.

The filtering application 112 can be embodied in any computer-readable medium for use by or in connection with an instruction execution system, apparatus, or device, such as a computer-based system or a processor-containing system. In the context of this disclosure, a “computer-readable medium” can be any means that can store, communicate, propagate, or transport a program for use by or in connection with the instruction execution system, apparatus, or device. The computer-readable medium can be, for example, among others, an electronic, magnetic, optical, electromagnetic, infrared, or semiconductor system, apparatus, device, or propagation medium now known or later developed.

FIG. 1A is a flow chart depicting an embodiment of a method 112-1 for filtering circuit analysis results comprising receiving circuit analysis results, as indicated in step 121, identifying a duplicate circuit analysis result among the received circuit analysis results, as indicated in step 122, and outputting a list of circuit analysis results that excludes the duplicate circuit analysis result, as indicated in step 123.

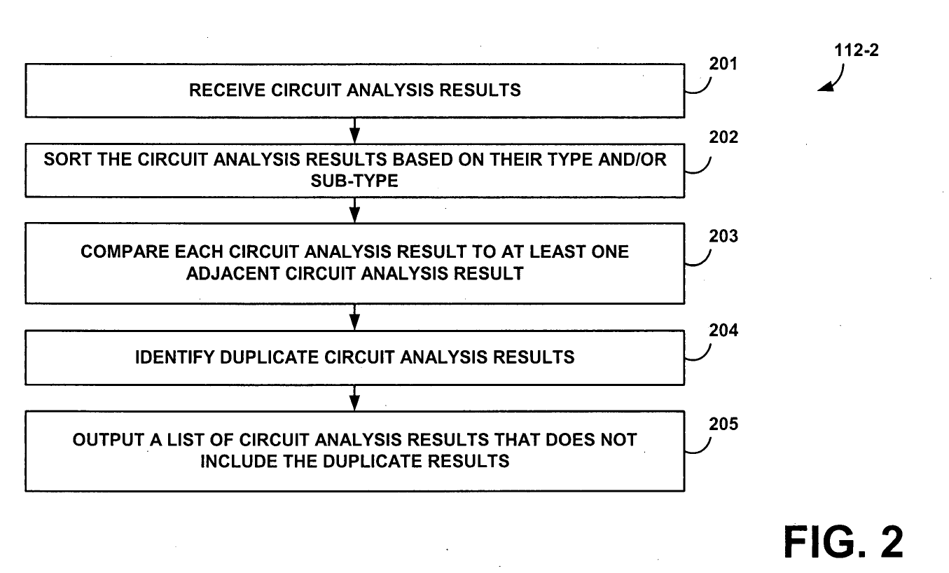

FIG. 2 is a flow chart depicting an embodiment of a method 112-2 for filtering circuit analysis results. The method 112-2 may be implemented by, for example, the filtering application 112 (FIG. 1). Circuit analysis results are received and then sorted based on their type and/or sub-type, as indicated in steps 201 and 202, respectively. The circuit analysis results may be generated by, for example, the ERC application 111 (FIG. 1) using electrical rules checking techniques now known or later developed. Examples of types and subtypes of ERC violations are discussed in more detail below.

Each circuit analysis result is compared to at least one adjacent result having the same type and/or sub-type, as indicated in step 203. Duplicate circuit analysis results are then identified, and a list of circuit analysis results that does not include the duplicate results is output, as indicated in steps 204 and 205, respectively.

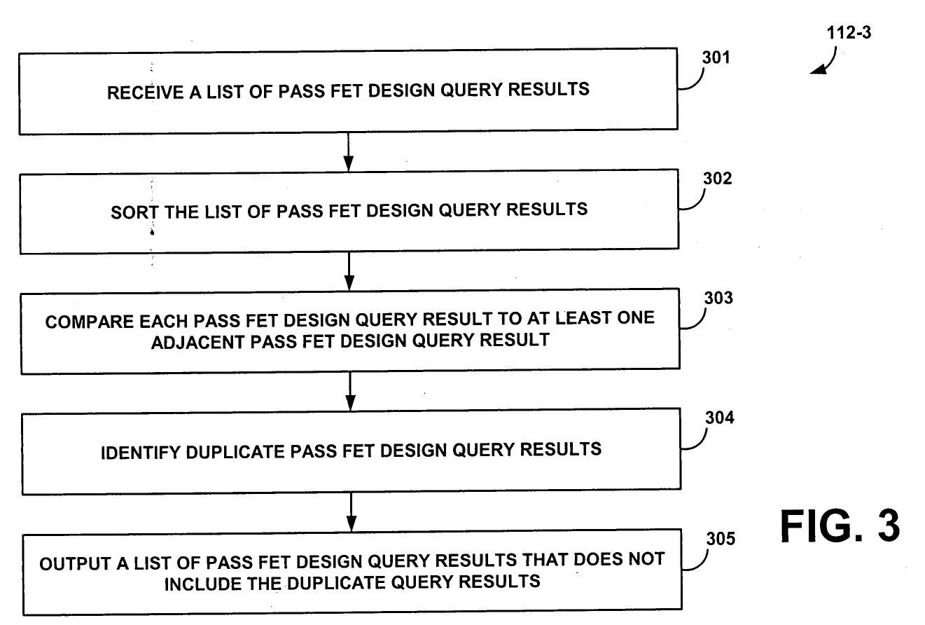

FIG. 3 is a flow chart depicting an embodiment of a method 112-3 for filtering circuit analysis results. The method 112-3 may be implemented by, for example, the filtering application 112 (FIG. 1). A list of pass-FET design query results is received and then sorted, as indicated in steps 301 and 302, respectively. The received pass-FET design query results may be generated by, for example, the ERC application 111 (FIG. 1) using electrical rules checking techniques now known or later developed. Examples of pass-FET design query results may include, for example, query results that are configured to enable detection of one or more of the following conditions:
Pass-gates that have PFET(s) but no NFET(s).
Pass-gates that have NFET(s) but no PFET(s).
Pass-FETs in series.

After the list of pass-FET design query results is received and sorted, each pass-FET design query-result is then compared to at least one adjacent result, as indicated in step 303. Duplicate pass-FET design query results are then identified, and a list of results that does not include the duplicate results is then output, as indicated in steps 304 and 305, respectively.

The following are examples of circuit analysis results related to pass-FETs that may be received (step 301):
Failure: Found 3 pass fets in series, terminating at node “shouldfail”. The passfet inputs were: in2 in1 in.

Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.

The above-mentioned circuit analysis results related to pass-FETs that may then be sorted alphabetically (step 302) by the filtering application 112 (FIG. 1) as follows:
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 3 pass fets in series, terminating at node “shouldfail”. The passfet inputs were: in2 in1 in.

The above-mentioned sorted results related to pass-FETs that may then be analyzed (step 303) by the filtering application 112 to determine duplicate entries (step 304). The following duplicate pass-FET entries may then be deleted or flagged by the filtering application 112:
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.
Failure: Found 5 pass fets in series, terminating at node “1a”. The passfet inputs were: ina3 ina2 ina1 ina ina1.

The filtering application 112 may then output (step 305) the following reduced set of pass-FET results that does not include the duplicate pass-FET entries shown above:
Failure: Found 5 pass fets in series, terminating at node “1a”. The passfet inputs were: ina3 ina2 ina1 ina ina1.
Failure: Found 3 pass fets in series, terminating at node “shouldfail”. The passfet inputs were: in2 in1 in.

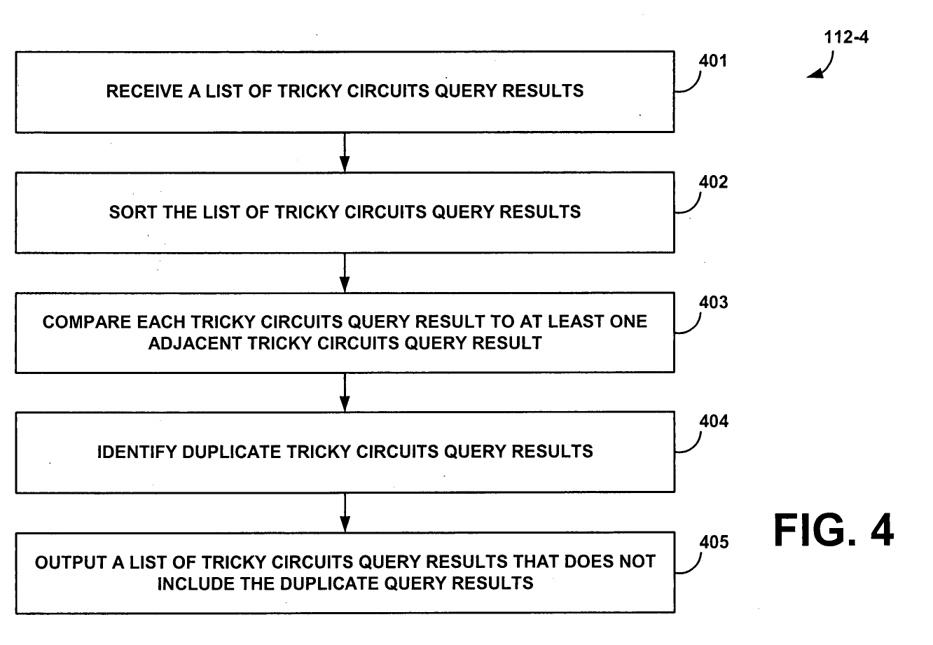

FIG. 4 is a flow chart depicting an embodiment of a method 112-4 for filtering circuit analysis results. The method 112-4 may be implemented by, for example, the filtering application 112 (FIG. 1). A list of tricky circuits query results is received and then sorted, as indicated in steps 401 and 402, respectively. Tricky circuits query results are configured to detect various types of miscellaneous circuit conditions. The received tricky circuits query results may be generated by, for example, the ERC application 111 (FIG. 1) using electrical rules checking techniques now known or later developed. Examples of tricky circuits query results may include, for example, query results that are configured to enable detection of one or more of the following conditions:
Logic that may create a glitch, a pulse, or otherwise “shape” a signal (e.g., a clock signal).
A block port that meets any of the following criteria:
   The port is an output and it is not driven by a static driver.
The port is an input and it drives a non-static receiver.
Whether the net resistance of certain cells exceeds a specified limit.

After the list of tricky circuits query results is received and sorted, each tricky circuits query-result is then compared to at least one adjacent result, as indicated in step 403. Duplicate tricky circuits query results are then identified, and a list of results that does not include the duplicate results is then output, as indicated in steps 404 and 405, respectively.

The following are examples of circuit analysis results related to tricky circuits that may be received (step 401):
Failure: The net “pck” is a block input and has a non-static receiver.
Failure: The net “pck” is a block input and has a non-static receiver.
Failure: The net “pck” is a block input and has a non-static receiver.
Failure: The net “pck” is a block input and has a non-static receiver.
Failure: The net “pck” is a block input and has a non-static receiver.
Failure: The net “pck” is a block input and has a non-static receiver.

The above-mentioned circuit analysis results related to tricky circuits that may then be sorted alphabetically (step 402) by the filtering application 112 (FIG. 1) as follows:
Failure: The net “pck” is a block input and has a non-static receiver.
Failure: The net “pck” is a block input and has a non-static receiver.
Failure: The net “pck” is a block input and has a non-static receiver.
Failure: The net “pck” is a block input and has a non-static receiver.
Failure: The net “pck” is a block input and has a non-static receiver.
Failure: The net “pck” is a block input and has a non-static receiver.

In the above example related to tricky circuits, the results are identical, so sorting the results does not alter their apparent order. The above-mentioned sorted results related to tricky circuits may then be analyzed by the filtering application 112 to determine duplicate entries (step 403). The following duplicated entries may then be deleted or flagged (step 404) by the filtering application 112:
Failure: The net “pck” is a block input and has a non-static receiver.
Failure: The net “pck” is a block input and has a non-static receiver.
Failure: The net “pck” is a block input and has a non-static receiver.
Failure: The net “pck” is a block input and has a non-static receiver.
Failure: The net “pck” is a block input and has a non-static receiver.

The filtering application 112 may then output (step 405) a reduced set of results as follows, that does not include the duplicate entries shown above:
Failure: The net “pck” is a block input and has a non-static receiver.

Note that in this example the reduced set of results comprises only one query result.

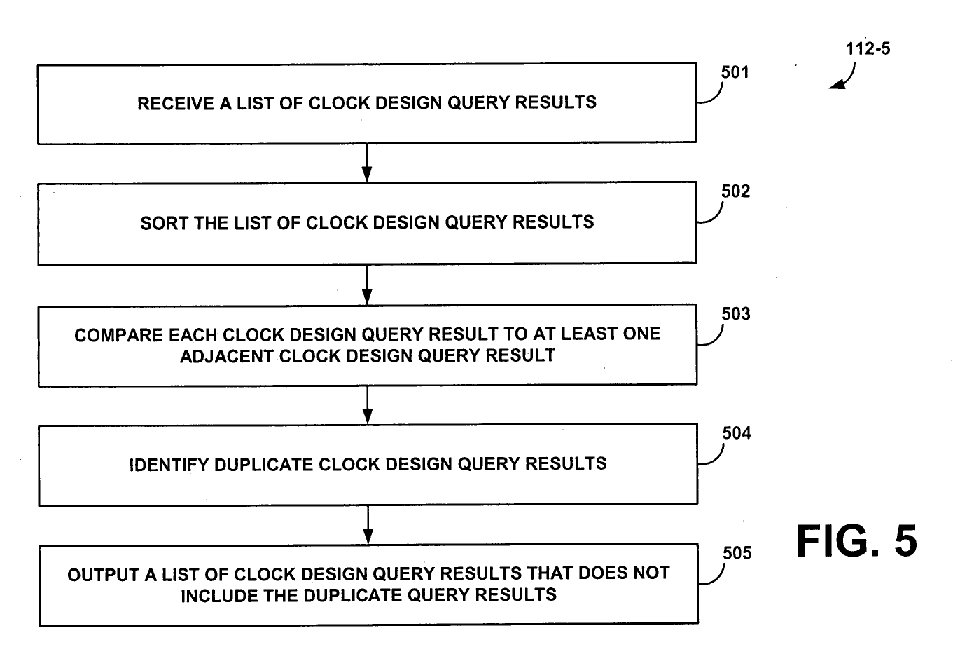

FIG. 5 is a flow chart depicting an embodiment of a method 112-5 for filtering circuit analysis results. The method 112-5 may be implemented by, for example, the filtering application 112 (FIG. 1). A list of clock-design query results is received and then sorted, as indicated in steps 501 and 502, respectively. The received clock-design query results may be generated by, for example, the ERC application 111 (FIG. 1) using electrical rules checking techniques now known or later developed. Examples of clock-design query results may include, for example, query results that are configured to enable detection of static gates that are used as buffers for clock signals, pulse clocks driving pulse generators, and/or clocks driving pass-FET diffusion inputs.

After the list of clock-design query results is received and sorted (steps 501 and 502), each clock-design query-result is then compared to at least one adjacent result, as indicated in step 503. Duplicate clock-design query results are then identified, and a list of results that does not include the duplicate results is then output, as indicated in steps 504 and 505, respectively.

The following are non-limiting examples of circuit analysis results that may be received (step 501):
Failure: The clock “miscclock/lower_pck/predriver/ncvdo” drives the static gate that creates the signal “miscclock/lower_pck/predriver/cvdob”.
Failure: The clock “miscclock/CVDO_PRECK_lo” drives the static gate that creates the signal “miscclock/lower_preck/predriver/bbclkin”.
Failure: The clock “miscclock/upper_pck/predriver/ncvdo” drives the static gate that creates the signal “miscclock/upper_pck/predriver/cvdob”.
Failure: The clock “miscclock/CVDO_PCK_up” drives the static gate that creates the signal “miscclock/upper_pck/predriver/ncvdo”.
Failure: The clock “miscclock/cvd_ck_lo/subcvd/slcbx” drives the static gate that creates the signal “miscclock/cvd_ck_lo/subcvd/cap”.
Failure: The clock “miscclock/cvd_ck_lo/subcvd/slcbx” drives the static gate that creates the signal “miscclock/cvd_ck_lo/subcvd/cap”.
Failure: The clock “miscclock/cvd_cks_lo/subcvd/slcbx” drives the static gate that creates the signal “miscclock/cvd_cks_lo/subcvd/cap”.
Failure: The clock “miscclock/upper_pck/predriver/cvdob” drives the static gate that creates the signal “miscclock/upper_pck/predriver/cvdobo”.
Failure: The clock “miscclock/cvd_cks_up/subcvd/slcbx” drives the static gate that creates the signal “miscclock/cvd_cks_up/subcvd/cap”.
Failure: The clock “miscclock/cvd_cks_up/subcvd/slcbx” drives the static gate that creates the signal “miscclock/cvd_cks_up/subcvd/cap”.
Failure: The clock “miscclock/upper_preck/predriver/bbclkin” drives the static gate that creates the signal “miscclock/upper_preck/predriver/bclkin”.
Failure: The clock “miscclock/CVDO_PCK_lo” drives the static gate that creates the signal “miscclock/lower_pck/predriver/ncvdo”.
Failure: The clock “miscclock/CVDO_PRECK_up” drives the static gate that creates the signal “miscclock/upper_preck/predriver/bbclkin”.
Failure: The clock “miscclock/cvd_preck_lo/subcvd/slcbx” drives the static gate that creates the signal “miscclock/cvd_preck_lo/subcvd/cap”.
Failure: The clock “SLCBO” drives the static gate that creates the signal “miscclock/cvd_pck_up/subcvd/slcbx”.
Failure: The clock “SLCBO” drives the static gate that creates the signal “miscclock/cvd_pck_lo/subcvd/cap”.
Failure: The clock “SLCBO” drives the static gate that creates the signal “miscclock/cvd_cks_up/subcvd/slcbx”.
Failure: The clock “SLCBO” drives the static gate that creates the signal “miscclock/cvd_cks_lo/subcvd/slcbx”.
Failure: The clock “SLCBO” drives the static gate that creates the signal “miscclock/cvd_preck_up/subcvd/cap”.
Failure: The clock “SLCBO” drives the static gate that creates the signal “miscclock/cvd_ck_lo/subcvd/cap”.
Failure: The clock “SLCBO” drives the static gate that creates the signal “miscclock/CVDO_PRECK_lo”.
Failure: The clock “SLCBO” drives the static gate that creates the signal “miscclock/cvd_ck_up/subcvd/cap”.
Failure: The clock “miscclock/cvd_preck_up/subcvd/slcbx” drives the static gate that creates the signal “miscclock/cvd_preck_up/subcvd/cap”.
Failure: The clock “miscclock/cvd_pck_lo/subcvd/slcbx” drives the static gate that creates the signal “miscclock/cvd_pck_lo/subcvd/cap”.
Failure: The clock “miscclock/cvd_pck_lo/subcvd/slcbx” drives the static gate that creates the signal “miscclock/cvd_pck_lo/subcvd/cap”.
Failure: The clock “miscclock/cvd_pck_up/subcvd/slcbx” drives the static gate that creates the signal “miscclock/cvd_pck_up/subcvd/cap”.
Failure: The clock “miscclock/cvd_pck_up/subcvd/slcbx” drives the static gate that creates the signal “miscclock/cvd_pck_up/subcvd/cap”.
Failure: The clock “miscclock/lower_pck/predriver/cvdob” drives the static gate that creates the signal “miscclock/lower_pck/predriver/cvdobo”.
Failure: The clock “miscclock/lower_preck/predriver/bbclkin” drives the static gate that creates the signal “miscclock/lower_preck/predriver/bclkin”.
Failure: The clock “miscclock/cvd_ck_up/subcvd/slcbx” drives the static gate that creates the signal “miscclock/cvd_ck_up/subcvd/cap”.
Failure: The clock “miscclock/cvd_ck_up/subcvd/slcbx” drives the static gate that creates the signal “miscclock/cvd_ck_up/subcvd/cap”.

The above-mentioned circuit analysis results related to clock design that may then be sorted alphabetically (step 502) by the filtering application 112 (FIG. 1) as follows:
Failure: The clock “miscclock/upper_preck/predriver/bbclkin” drives the static gate that creates the signal “miscclock/upper_preck/predriver/bclkin”.
Failure: The clock “miscclock/upper_pck/predriver/ncvdo” drives the static gate that creates the signal “miscclock/upper_pck/predriver/cvdob”.
Failure: The clock “miscclock/upper_pck/predriver/cvdob” drives the static gate that creates the signal “miscclock/upper_pck/predriver/cvdobo”.
Failure: The clock “miscclock/lower_preck/predriver/bbclkin” drives the static gate that creates the signal “miscclock/lower_preck/predriver/bclkin”.
Failure: The clock “miscclock/lower_pck/predriver/ncvdo” drives the static gate that creates the signal “miscclock/lower_pck/predriver/cvdob”.
Failure: The clock “miscclock/lower_pck/predriver/cvdob” drives the static gate that creates the signal “miscclock/lower_pck/predriver/cvdobo”.
Failure: The clock “miscclock/cvd_preck_up/subcvd/slcbx” drives the static gate that creates the signal “miscclock/cvd_preck_up/subcvd/cap”.
Failure: The clock “miscclock/cvd_preck_lo/subcvd/slcbx” drives the static gate that creates the signal “miscclock/cvd_preck_lo/subcvd/cap”.
Failure: The clock “miscclock/cvd_pck_up/subcvd/slcbx” drives the static gate that creates the signal “miscclock/cvd_pck_up/subcvd/cap”.
Failure: The clock “miscclock/cvd_pck_up/subcvd/slcbx” drives the static gate that creates the signal “miscclock/cvd_pck_up/subcvd/cap”.
Failure: The clock “miscclock/cvd_pck_lo/subcvd/slcbx” drives the static gate that creates the signal “miscclock/cvd_pck_lo/subcvd/cap”.
Failure: The clock “miscclock/cvd_pck_lo/subcvd/slcbx” drives the static gate that creates the signal “miscclock/cvd_pck_lo/subcvd/cap”.
Failure: The clock “miscclock/cvd_cks_up/subcvd/slcbx” drives the static gate that creates the signal “miscclock/cvd_cks_up/subcvd/cap”.
Failure: The clock “miscclock/cvd_cks_up/subcvd/slcbx” drives the static gate that creates the signal “miscclock/cvd_cks_up/subcvd/cap”.
Failure: The clock “miscclock/cvd_cks_lo/subcvd/slcbx” drives the static gate that creates the signal “miscclock/cvd_cks_lo/subcvd/cap”.
Failure: The clock “miscclock/cvd_ck_up/subcvd/slcbx” drives the static gate that creates the signal “miscclock/cvd_ck_up/subcvd/cap”.
Failure: The clock “miscclock/cvd_ck_up/subcvd/slcbx” drives the static gate that creates the signal “miscclock/cvd_ck_up/subcvd/cap”.
Failure: The clock “miscclock/cvd_ck_lo/subcvd/slcbx” drives the static gate that creates the signal “miscclock/cvd_ck_lo/subcvd/cap”.
Failure: The clock “miscclock/cvd_ck_lo/subcvd/slcbx” drives the static gate that creates the signal “miscclock/cvd_ck_lo/subcvd/cap”.
Failure: The clock “miscclock/CVDO_PRECK_up” drives the static gate that creates the signal “miscclock/upper_preck/predriver/bbclkin”.
Failure: The clock “miscclock/CVDO_PRECK_lo” drives the static gate that creates the signal “miscclock/lower_preck/predriver/bbclkin”.
Failure: The clock “miscclock/CVDO_PCK_up” drives the static gate that creates the signal “miscclock/upper_pck/predriver/ncvdo”.
Failure: The clock “miscclock/CVDO_PCK_lo” drives the static gate that creates the signal “miscclock/lower_pck/predriver/ncvdo”.
Failure: The clock “SLCBO” drives the static gate that creates the signal “miscclock/cvd_preck_up/subcvd/cap”.
Failure: The clock “SLCBO” drives the static gate that creates the signal “miscclock/cvd_pck_up/subcvd/slcbx”.
Failure: The clock “SLCBO” drives the static gate that creates the signal “miscclock/cvd_pck_lo/subcvd/cap”.
Failure: The clock “SLCBO” drives the static gate that creates the signal “miscclock/cvd_cks_up/subcvd/slcbx”.
Failure: The clock “SLCBO” drives the static gate that creates the signal “miscclock/cvd_cks_lo/subcvd/slcbx”.
Failure: The clock “SLCBO” drives the static gate that creates the signal “miscclock/cvd_ck_up/subcvd/cap”.
Failure: The clock “SLCBO” drives the static gate that creates the signal “miscclock/cvd_ck_lo/subcvd/cap”.
Failure: The clock “SLCBO” drives the static gate that creates the signal “miscclock/CVDO_PRECK_lo”.

The above-mentioned sorted results related to clock design may be analyzed (steps 503 and 504) by the filtering application 112, which may delete or flag the following duplicate entries:
Failure: The clock “miscclock/cvd_pck_up/subcvd/slcbx” drives the static gate that creates the signal “miscclock/cvd_pck_up/subcvd/cap”.
Failure: The clock “miscclock/cvd_pck_lo/subcvd/slcbx” drives the static gate that creates the signal “miscclock/cvd_pck_lo/subcvd/cap”.
Failure: The clock “miscclock/cvd_cks_up/subcvd/slcbx” drives the static gate that creates the signal “miscclock/cvd_cks_up/subcvd/cap”.
Failure: The clock “miscclock/cvd_ck_up/subcvd/slcbx” drives the static gate that creates the signal “miscclock/cvd_ck_up/subcvd/cap”.
Failure: The clock “miscclock/cvd_ck_lo/subcvd/slcbx” drives the static gate that creates the signal “miscclock/cvd_ck_lo/subcvd/cap”.

The filtering application 112 may then output (step 504) the following reduced set of results that does not include the duplicate clock design entries shown above:
Failure: The clock “miscclock/upper_preck/predriver/bbclkin” drives the static gate that creates the signal “miscclock/upper_preck/predriver/bclkin”.
Failure: The clock “miscclock/upper_pck/predriver/ncvdo” drives the static gate that creates the signal “miscclock/upper_pck/predriver/cvdob”.
Failure: The clock “miscclock/upper_pck/predriver/cvdob” drives the static gate that creates the signal “miscclock/upper_pck/predriver/cvdobo”.
Failure: The clock “miscclock/lower_preck/predriver/bbclkin” drives the static gate that creates the signal “miscclock/lower_preck/predriver/bclkin”.
Failure: The clock “miscclock/lower_pck/predriver/ncvdo” drives the static gate that creates the signal “miscclock/lower_pck/predriver/cvdob”.
Failure: The clock “miscclock/lower_pck/predriver/cvdob” drives the static gate that creates the signal “miscclock/lower_pck/predriver/cvdobo”.
Failure: The clock “miscclock/cvd_preck_up/subcvd/slcbx” drives the static gate that creates the signal “miscclock/cvd_preck_up/subcvd/cap”.
Failure: The clock “miscclock/cvd_preck_lo/subcvd/slcbx” drives the static gate that creates the signal “miscclock/cvd_preck_lo/subcvd/cap”.
Failure: The clock “miscclock/cvd_pck_up/subcvd/slcbx” drives the static gate that creates the signal “miscclock/cvd_ck_up/subcvd/cap”.
Failure: The clock “miscclock/cvd_pck_lo/subcvd/slcbx” drives the static gate that creates the signal “miscclock/cvd_pck_lo/subcvd/cap”.
Failure: The clock “miscclock/cvd_cks_up/subcvd/slcbx” drives the static gate that creates the signal “miscclock/cvd_cks_up/subcvd/cap”.
Failure: The clock “miscclock/cvd_cks_lo/subcvd/slcbx” drives the static gate that creates the signal “miscclock/cvd_cks_lo/subcvd/cap”.
Failure: The clock “miscclock/cvd_ck_up/subcvd/slcbx” drives the static gate that creates the signal “miscclock/cvd_ck_up/subcvd/cap”.
Failure: The clock “miscclock/cvd_ck_lo/subcvd/slcbx” drives the static gate that creates the signal “miscclock/cvd_ck_lo/subcvd/cap”.
Failure: The clock “miscclock/CVDO_PRECK_up” drives the static gate that creates the signal “miscclock/upper_preck/predriver/bbclkin”.
Failure: The clock “miscclock/CVDO_PRECK_lo” drives the static gate that creates the signal “miscclock/lower_preck/predriver/bbclkin”.
Failure: The clock “miscclock/CVDO_PCK_up” drives the static gate that creates the signal “miscclock/upper_pck/predriver/ncvdo”.
Failure: The clock “miscclock/CVDO_PCK_lo” drives the static gate that creates the signal “miscclock/lower_pck/predriver/ncvdo”.
Failure: The clock “SLCBO” drives the static gate that creates the signal “miscclock/cvd_preck_up/subcvd/cap”.
Failure: The clock “SLCBO” drives the static gate that creates the signal “miscclock/cvd_pck_up/subcvd/slcbx”.
Failure: The clock “SLCBO” drives the static gate that creates the signal “miscclock/cvd_pck_lo/subcvd/cap”.
Failure: The clock “SLCBO” drives the static gate that creates the signal “miscclock/cvd_cks_up/subcvd/slcbx”.
Failure: The clock “SLCBO” drives the static gate that creates the signal “miscclock/cvd_cks_lo/subcvd/slcbx”.
Failure: The clock “SLCBO” drives the static gate that creates the signal “miscclock/cvd_ck_up/subcvd/cap”.
Failure: The clock “SLCBO” drives the static gate that creates the signal “miscclock/cvd_ck_lo/subcvd/cap”.
Failure: The clock “SLCBO” drives the static gate that creates the signal “miscclock/CVDO_PRECK_lo”.

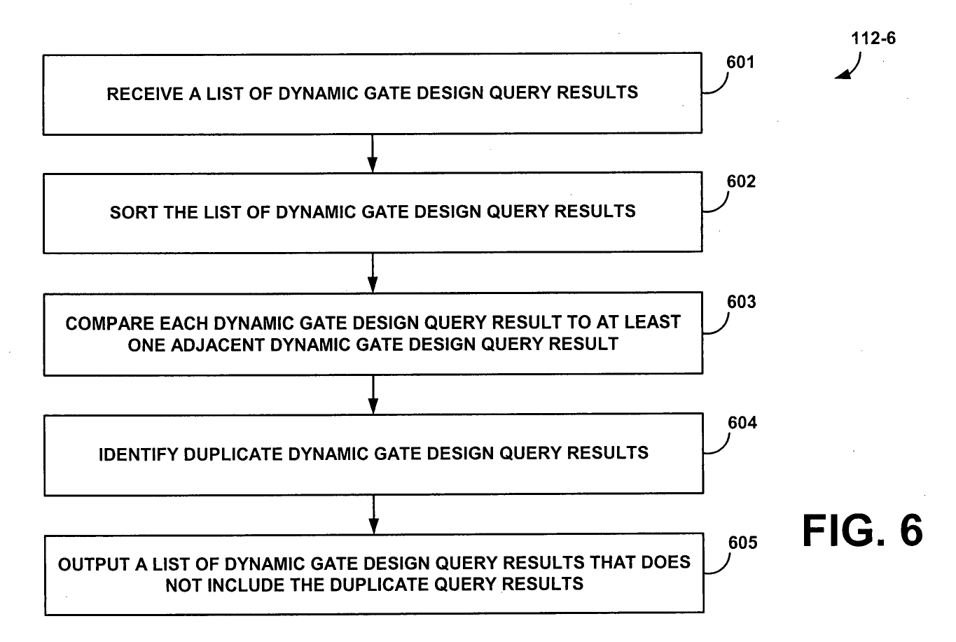

FIG. 6 is a flow chart depicting an embodiment of a method 112-6 for filtering circuit analysis results. The method 112-6 may be implemented by, for example, the filtering application 112 (FIG. 1). A list of dynamic-gate-design query results is received and then sorted, as indicated in steps 601 and 602, respectively. The received dynamic-gate-design query results may be generated by, for example, the ERC application 111 (FIG. 1) using electrical rules checking techniques now known or later developed. Examples of dynamic-gate-design query results may include, for example, query results that are configured to enable detection of one or more of the following conditions:
Charge sharing opportunities from an NFET pull-down of a dynamic gate to a precharge node.
Charge sharing opportunities from a precharge node through a pass-FET to another node.
Feedback FETs in dynamic gates that are not large enough to hold the charge of a precharge node.
Dynamic gates whose precharger is not large enough to precharge a respective gate in the low period of a clock signal.
Dynamic gates whose NFET pull-down tree is not large enough to evaluate the gate in the high period of a clock signal.
Precharge nodes without a feedback PFET.

After the list of dynamic-gate-design query results is received and sorted, each dynamic-gate-design query-result is then compared to at least one adjacent result, as indicated in step 603. Duplicate dynamic-gate-design query results are then identified, and a list of results that does not include the duplicate results is then output, as indicated in steps 604 and 605, respectively.

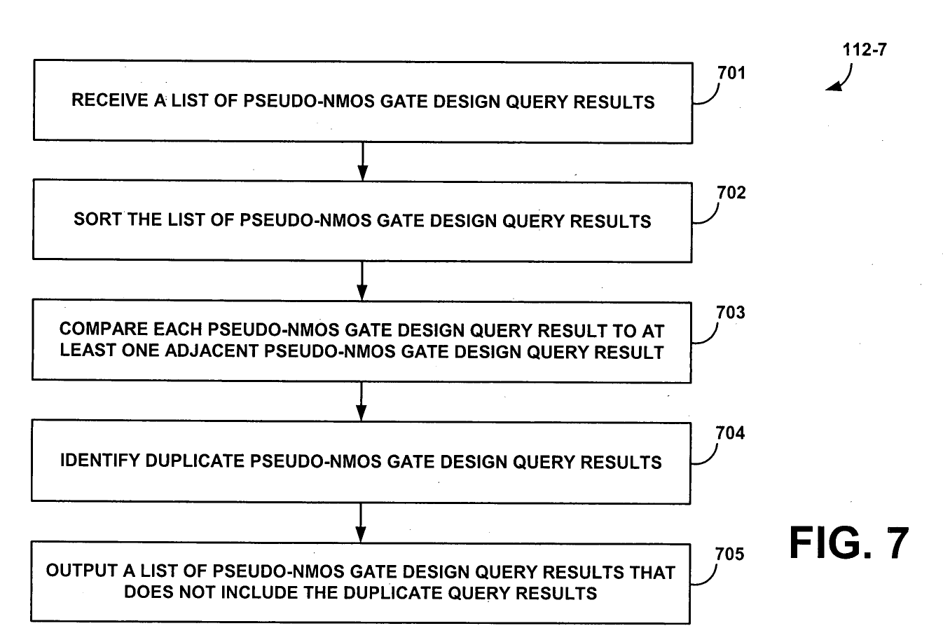

FIG. 7 is a flow chart depicting an embodiment of a method 112-7 for filtering circuit analysis results. The method 112-7 may be implemented by, for example, the filtering application 112 (FIG. 1). A list of pseudo-NMOS gate design query results is received and then sorted, as indicated in steps 701 and 702, respectively. The received pseudo-NMOS gate design query results may be generated by, for example, the ERC application 111 (FIG. 1) using electrical rules checking techniques now known or later developed. Examples of pseudo-NMOS gate design query results may include, for example, query results that are configured to enable detection of Pseudo-NMOS gates that have a worst-case low output voltage that is too high, pseudo-NMOS gates that drive a Vt sensitive gate (e.g., another pseudo-NMOS gate, a precharge gate input, or a set FET gate), and/or pseudo-NMOS gates that have large PFET load devices.

After the list of pseudo-NMOS gate design query results is received and sorted, each pseudo-NMOS gate design query-result is then compared to at least one adjacent result, as indicated in step 703. Duplicate pseudo-NMOS gate design query results are then identified, and a list of results that does not include the duplicate results is then output, as indicated in steps 704 and 705, respectively.

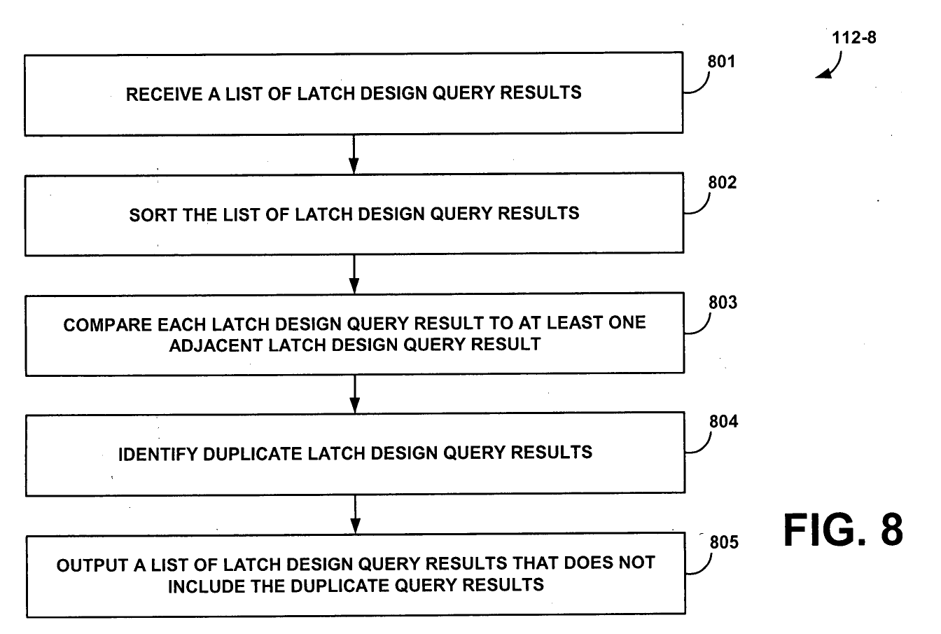

FIG. 8 is a flow chart depicting an embodiment of a method 112-8 for filtering circuit analysis results. The method 112-8 may be implemented by, for example, the filtering application 112 (FIG. 1). A list of latch-design query results is received and then sorted, as indicated in steps 801 and 802, respectively. The received latch-design query results may be generated by, for example, the ERC application 111 (FIG. 1) using electrical rules checking techniques now known or later developed. Examples of latch-design query results may include, for example, query results that are configured to enable detection of one or more of the following conditions:
Charge sharing opportunities from a latch node to the inputs of pass-FETs.
Charge sharing opportunities from series pass-FETs to a latch node.
Problems a driver circuit might have in setting a logic 1 or a logic 0 into a latch.
Problems feedback FETs might have keeping a charge on a latch node.
Latch nodes that do not have any feedback FETs to sustain stored values.

After the list of latch-design query results is received and sorted, each latch-design query-result is then compared to at least one adjacent result, as indicated in step 803. Duplicate latch-design query results are then identified, and a list of results that does not include the duplicate results is then output, as indicated in steps 804 and 805, respectively.

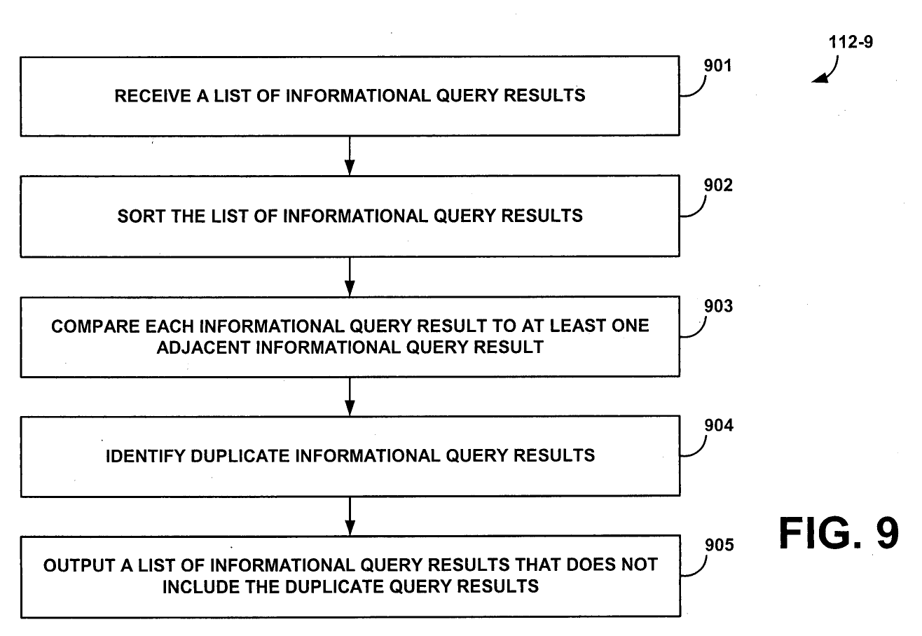

FIG. 9 is a flow chart depicting an embodiment of a method 112-9 for filtering circuit analysis results. The method 112-9 may be implemented by, for example, the filtering application 112 (FIG. 1). A list of informational query results is received and then sorted, as indicated in steps 901 and 902, respectively. The received informational query results may be generated by, for example, the ERC application 111 (FIG. 1) using electrical rules checking techniques now known or later developed. Examples of informational query results may include, for example, query results that are configured to enable detection of one or more of the following conditions:
Low-Vt FETs used in non-recommended ways.
Unrecognized circuits.
A FET that has a gate, drain, and/or source that are coupled to each other (i.e., shorted).
Pre-discharge nodes.
FETs that connect VDD and ground and conduct a short-circuit current.
A stack of FETs having too many FETs.
FETs that do not have directionality information set, or that are bi-directional.
A logic gate whose trip point is either greater or smaller than recommended for that type of gate.
All the node types in the design: inputs, outputs, latches, latch inputs, precharge nodes, precharge inputs, clocks, static gate outputs, outputs of gates driven by precharge nodes.
A FET that is outside the range for width and length recommended for its type (e.g., pass-FET, clock driver, feedback, bypass cap, etc.).
An interstitial node in a dynamic gate, where the node is coupled to at least 3 FETs, but not to a precharger.
Complementary pass-FETs that have a P:N ratio outside the recommended limits.
Complementary pass-FETs that have control signals that do not have opposite values.
Multiplexers with more than the recommended number of multiplexer inputs.
Pass-FETs that remain “on” indefinitely.
Nodes that cannot toggle due to an input to a gate coupled to VDD or GND.
NFETs that appear to be pulling a node to VDD.
The recommended number of pass-FETs in series has been exceeded.
Nodes that have more capacitance than recommended.

After the list of informational query results is received and sorted, each informational query-result is then compared to at least one adjacent result, as indicated in step 903. Duplicate informational query results are then identified, and a list of results that does not include the duplicate results is then output, as indicated in steps 904 and 905, respectively.

It should be emphasized that the above-described embodiments are mere examples of possible implementations. Therefore, many variations and modifications may be made to the above-described embodiments. All such modifications and variations are intended to be included herein within the scope of the disclosure.

1. A method comprising:
receiving circuit analysis results;
identifying a duplicate circuit analysis result among the received circuit analysis results; and
outputting a list of circuit analysis results that excludes the duplicate circuit analysis result.

2. The method of claim 1, further comprising:
sorting the circuit analysis results.

3. The method of claim 2, wherein the circuit analysis results are sorted alphabetically.

4. The method of claim 2, further comprising:
comparing each of the circuit analysis results with an adjacent circuit analysis result.

5. The method of claim 2, wherein the circuit analysis results are sorted based on types of circuit analysis results.

6. The method of claim 5, wherein the types of circuit analysis results comprise a type of result configured to enable detection of latch design defects.

7. The method of claim 5, wherein the types of circuit analysis results comprise a type of result configured to enable detection of dynamic gate design defects.

8. The method of claim 5, wherein the types of circuit analysis results comprise a type of result configured to enable detection of clock design defects.

9. The method of claim 5, wherein the types of circuit analysis results comprise a type of result configured to enable detection of pseudo-NMOS gate design defects.

10. The method of claim 5, wherein the types of circuit analysis results comprise a type of result configured to enable detection of pass-FET design defects.

11. A system comprising:
memory configured to store program code; and
at least one processor that is programmed by the program code to:
identify a duplicate circuit analysis result; and
output a list of circuit analysis results that excludes the duplicate circuit analysis result.

12. The system of claim 11, wherein the at least one processor is further programmed to sort the circuit analysis results.

13. The system of claim 12, wherein the circuit analysis results are sorted alphabetically.

14. The system of claim 12, wherein the at least one processor is further programmed to compare each of the circuit analysis results with an adjacent circuit analysis result.

15. The system of claim 12, wherein the circuit analysis results are sorted based on types of circuit analysis results.

16. The system of claim 15, wherein the types of circuit analysis results comprise a type of result configured to enable detection of latch design defects.

17. The system of claim 15, wherein the types of circuit analysis results comprise a type of result configured to enable detection of dynamic gate design defects.

18. The system of claim 15, wherein the types of circuit analysis results comprise a type of result configured to enable detection of clock design defects.

19. The system of claim 15, wherein the types of circuit analysis results comprise a type of result configured to enable detection of pseudo-NMOS gate design defects.

20. The system of claim 15, wherein the types of circuit analysis results comprise a type of result configured to enable detection of pass-FET design defects.

21. A computer readable medium having computer-readable instructions configured to:
receive circuit analysis results;
identify a duplicate circuit analysis result among the received circuit analysis results; and
output a list of circuit analysis results that excludes the duplicate circuit analysis result.

22. The computer readable medium of claim 1, wherein the computer-readable instructions are further configured to:
sort the circuit analysis results; and
compare each of the circuit analysis results with an adjacent circuit analysis result.

23. A system comprising:
means for receiving circuit analysis results;
means for identifying a duplicate circuit analysis result among the received circuit analysis results; and
means for outputting a list of circuit analysis results that excludes the duplicate circuit analysis result.

24. The system of claim 23, further comprising:
means for sorting the circuit analysis results; and
means for comparing each of the circuit analysis results with an adjacent circuit analysis result.
